(19) United States
(12) Patent Application Publication
(10) Pub. No.: US 2009/0015476 A1
(43) Pub. Date: Jan. 15, 2009

(54) VARIABLE DIRECTIVITY ANTENNA APARATUS

(75) Inventors: Eiji Shibuya, Kobe-shi (JP); Kiyotaka Tatekawa, Kobe-shi (JP); Takayuki Yoshii, Kobe-shi (JP)

Correspondence Address: DUANE MORRIS LLP - Philadelphia;IP DEPARTMENT, 30 SOUTH 17TH STREET, PHILADELPHIA, PA, 19103-4196, US

(73) Assignee: DX ANTENNA COMPANY, LIMITED, Kobe-shi (JP)

(21) Appl. No.: 12/169,018

(22) Filed: Jul. 8, 2008

(30) Foreign Application Priority Data
Jul. 12, 2007 (JP) 2007-182997

(51) Int. Cl. H01Q 3/00

(52) U.S. Cl. 342/374

(57) ABSTRACT

A variable directivity antenna apparatus (1) includes an output terminal (40) at which reception signals transmitted through a coaxial cable (42) are outputted. The directivity pattern of the antenna apparatus (1) is varied in response to a directivity control signal supplied to the output terminal (40) through the coaxial cable (42). The variable directivity antenna apparatus (1) further includes changeover switches (8, 12, 14, 22, 32, 34, 38) operated to fix the orientation of directivity in a predetermined direction in response to the coupling of a power supply adapter (64).

This invention relates to a variable directivity antenna apparatus having a variable directivity, and, more particularly, to such an antenna apparatus of which direction of directivity can be fixed.

### BACKGROUND OF THE INVENTION

An example of variable directivity antenna apparatus is shown in FIGS. 8-12 of WO2004/091043 (corresponding to U.S. Pat. No. 7,277,063). This variable directivity antenna apparatus includes two UHF-band antenna elements disposed to intersect each other at right angles. The levels of signals received by the respective antenna elements are adjusted in variable attenuators disposed in association with the respective antenna elements, and the level-adjusted signals are combined together to form an output signal. By varying the amounts of attenuation provided by the respective variable attenuators, the direction of combined directivities of the two UHF-band antenna elements is varied. In this way, the directivity of the antenna apparatus is directed to the direction from which a UHF-band television broadcast signal comes. Control signals for varying the amounts of attenuation provided by the variable attenuators are provided to output terminals of the variable directivity antenna apparatus from a television receiver through a transmission line. The variable directivity antenna apparatus can be used only with special television receivers that can provide such control signals.

Thus, the variable directivity antenna apparatus with the above-described arrangement cannot be used all types of television receivers. This variable directivity antenna apparatus cannot be used with common television receivers in use in areas where a plurality of television broadcast waves come from predetermined fixed directions, and, therefore there is no need for the directivity of antenna apparatus to be variable, and, hence, television receivers are no arranged to provide the above-described control signals.

An object of the present invention is to provide a variable directivity antenna apparatus which can be used not only with a special receiver but also with a common receiver.

### SUMMARY OF THE INVENTION

According to an aspect of the present invention, a variable directivity antenna apparatus includes an output terminal at which a received signal transmitted through a transmission line is developed. The direction of directivity of the variable directivity antenna apparatus is varied in accordance with a directivity control signal supplied to the output terminal through the transmission line. Switching means is provided for fixing the directivity to a predetermined direction in response to the operation of the switching means.

The variable directivity antenna apparatus with the above-described arrangement can have its directivity varied by the application of the directivity control signal thereto through the transmission line from, for example, a receiver capable of providing such directivity control signal. The direction or orientation of directivity can be fixed by operating the switching means. There is no need for sending the directivity control signal for the purpose of fixing the direction of the directivity. Accordingly, the variable directivity antenna apparatus can be used with any general-use receiver.

The variable directivity antenna apparatus according this aspect may be operated from operating power supplied to the output terminal through the transmission line. The antenna apparatus can also be operated from operating power supplied to a power supply terminal provided separate from the output terminal. The switching means is switched to fix the direction of directivity to a predetermined direction, when operating power is supplied to the separate power supply terminal.

With this arrangement, when the receiver capable of providing the directivity control signal is used with this variable directivity antenna apparatus, operating power is supplied to the antenna apparatus from the receiver. When the antenna apparatus is used with a common receiver, which is not arranged to provide such directivity control signal, operating power is supplied to the antenna apparatus from a separate power supply to the power supply terminal. In addition, in response to the supply of the operating power to the power supply terminal, the switching means is switched to fix the direction of directivity to a predetermined direction. In other words, there is no need for a user to take the trouble to operate the switching means to fix the direction of directivity.

The variable directivity antenna apparatus according to this aspect may include a plurality of antenna elements and directivity varying means for electrically processing signals received at the antenna elements to vary the directivity. The switching means provides a directivity fixing control signal in response to operation of the switching means. The directivity varying means is responsive to the directivity control signal by processing reception signals received at the respective antenna elements to thereby vary the direction of directivity, and also is responsive to the directivity fixing control signal by processing the reception signals to thereby fix the direction of directivity.

With this arrangement, what is required for either varying or fixing the direction of directivity is only to provide control signals to the directivity varying means.

The variable directivity antenna apparatus may include amplifying means for amplifying the reception signals received at the respective antenna elements before coupling them to the output terminal. The amplifying means operates when operating power is supplied to the output terminal or to the separate power supply terminal.

With this arrangement, when the antenna apparatus is used either with a receiver capable of providing a control signal or with a common receiver incapable of providing a control signal, the reception signals can be amplified before being outputted.

### BRIEF DESCRIPTION OF THE DRAWINGS

FIG. 1 illustrates how two dipole antennas are disposed when they are used in a variable directivity antenna apparatus according to an embodiment of the present invention.

FIG. 2 is a block circuit diagram of the variable directivity antenna apparatus.

FIGS. 3A, 3B, 3C and 3D show how the directivity pattern of the variable directivity antenna apparatus varies.

FIG. 4 is a perspective view of the variable directivity antenna.

FIGS. 5A and 5B are block diagrams of the variable directivity antenna apparatus in different, two uses, respectively.

FIG. 6 is a directivity pattern, when fixed, of the variable directivity antenna apparatus.

### BEST MODE FOR CARRYING OUT THE INVENTION

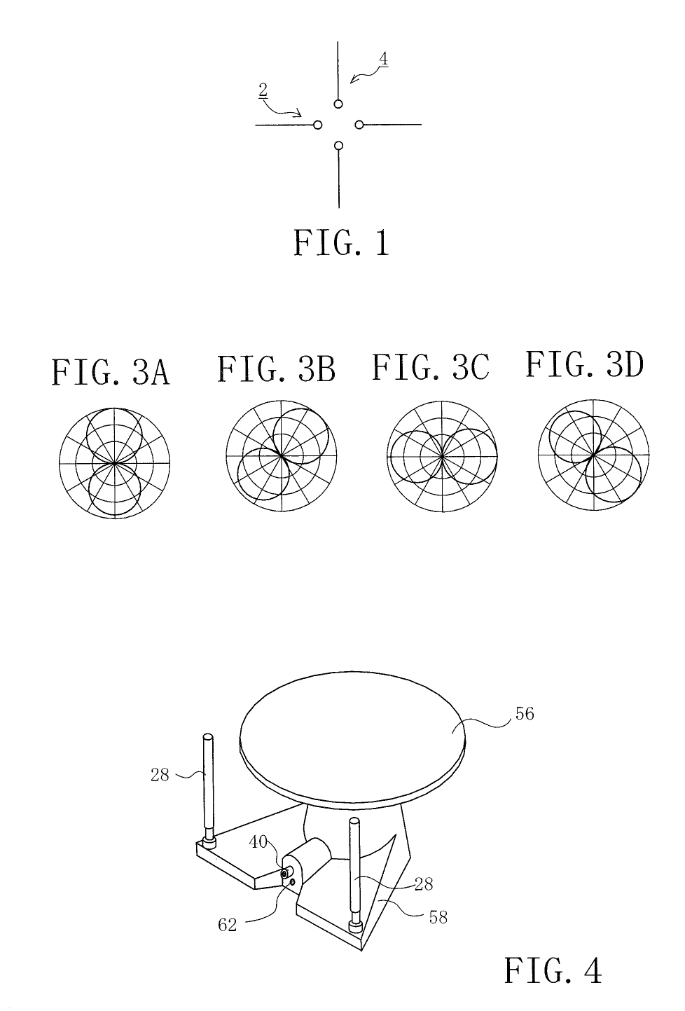

A variable directivity antenna apparatus 1 according to an embodiment of the present invention includes a plurality, e.g. two, of dipole antennas 2 and 4, as shown in FIG. 1. The dipole antennas 2 and 4 have the same length and can receive, e.g. UHF television broadcast signals. The dipole antennas 2 and 4 are disposed in such a manner as to orthogonally interest each other in a horizontal plane, for example. Each of the dipole antennas 2 and 4 exhibits an 8-shaped directivity pattern.

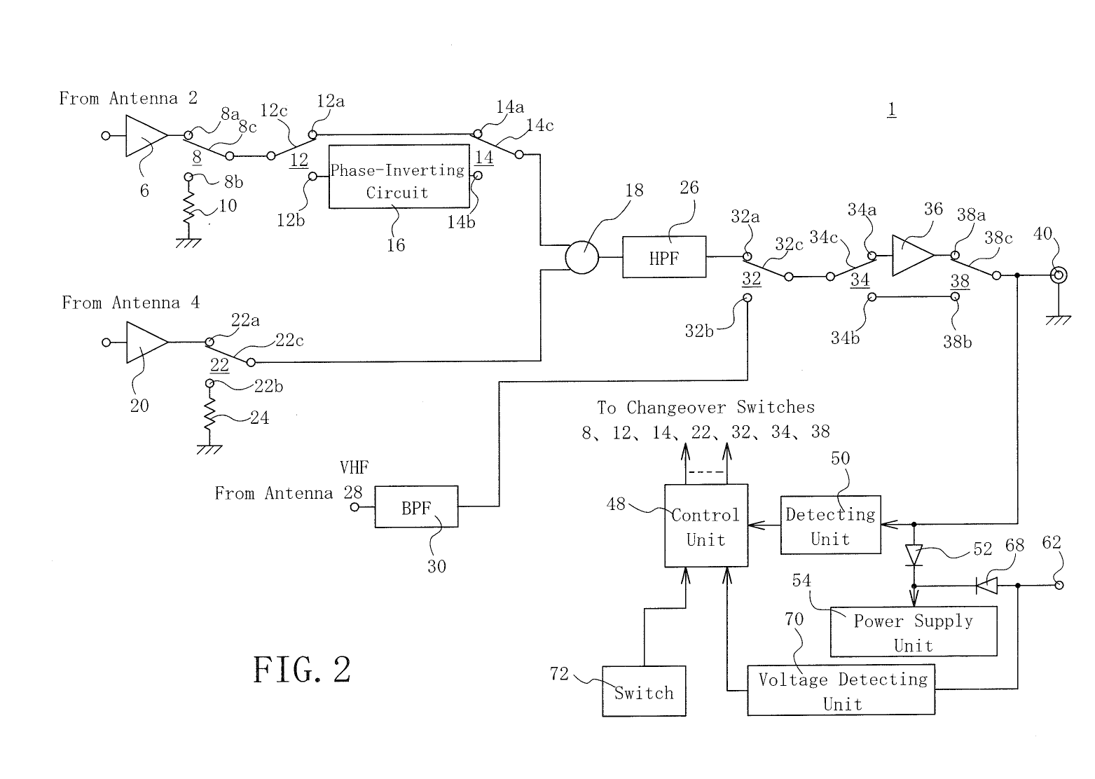

As shown in FIG. 2, a reception signal received at the dipole antenna 2 is amplified in an amplifier 6 before it is applied to switching means, e.g. a changeover switch 8 at its contact 8a. The changeover switch 8 includes also a contact 8b. A dummy resistor 10 is connected between the contact 8b and a point of reference potential, e.g. the ground potential. The changeover switch 8 also has a contact arm 8c which is placed to contact either one of the contacts 8a and 8b. The contact arm 8c of the changeover switch 8 is connected to a contact arm 12c of another changeover switch 12, which includes contacts 12a and 12b. The contact 12a is connected to a contact 14a of still another changeover switch 14. The contact 12b is connected to a contact 14b of the changeover switch 14 through a phase-inverting circuit 16. A contact arm 14c of the changeover switch 14, which is placed to contact either one of the contacts 14a and 14b, is connected to a first input terminal of combining means, e.g. a combiner 18.

When the contact arms 8c, 12c and 14c of the changeover switches 8, 12 and 14 are in contact with the contacts 8a, 12a and 14a, respectively, the reception signal from the dipole antenna 2 is applied as it is to the first input terminal of the combiner 18. With the contact arm 8c of the changeover switch 8 connected to the contact 8a, and with the contact arms 12c and 14c of the switches 12 and 14 connected respectively to the contacts 12b and 14b, a phase-inverted version of the reception signal from the dipole antenna 2 is coupled to the first input of the combiner 18. When the contact arm 8c of the changeover switch 8 is in contact with the contact 8b, the reception signal from the dipole antenna 2 is not coupled to the input of the combiner 18 regardless of the states the changeover switches 12 and 14 are in.

A reception signal from the dipole antenna 4 is amplified in an amplifier 20 and, then, is coupled to a contact 22a of a changeover switch 22. The changeover switch 22 has a contact 22b connected to the ground potential via a dummy resistor 24. A contact arm 22c of the changeover switch 22, which is to be brought into contact with either the contact 22a or 22b, is connected to the other, second input of the combiner 18.

With the contact arm 22c of the changeover switch 22 in contact with the contact 22a, the reception signal from the dipole antenna 4 is applied as it is to the second input of the combiner 18. With the contact arm 22c contacting the contact 22b, the reception signal from the dipole antenna 4 is not coupled to the second input terminal of the combiner 18.

Let it be assumed, for example, that the contact arms 8c, 12c and 14c of the changeover switches 8, 12 and 14 are in contact with the contacts 8a, 12a and 14a, respectively, and that the contact arm 22c of the changeover switch 22 is in contact with the contact 22b. In this case, only the reception signal from the dipole antenna 2 is developed at an output terminal of the combiner 18, and, thus, the composite directivity pattern of the two dipole antennas 2 and 4 is 8-shaped, as shown in FIG. 3A, in which the reception signal level is maximum in the direction perpendicular to the length of the dipole antenna 2.

When the contact arm 22c of the changeover switch 22 is brought into contact with the contact 22a, with the contacts of the changeover switches 8, 12 and 14 remaining in the above-described positions, the reception signals from the dipole antennas 2 and 4 are coupled to the first and second input terminals of the combiner 18, respectively, where they are combined with each other. The thus combined reception signals exhibit a composite directivity pattern as shown in FIG. 3B, which is a version of the directivity pattern of FIG. 3A rotated clockwise by about 45 degrees.

With the contact arm 8c of the changeover switch 8 contacting the contact 8b, and with the contact arm 22c of the switch 22 contacting the contact 22a, only the reception signal from the dipole antenna 4 is coupled to the combiner 18, so that the composite directivity pattern of the dipole antennas 2 and 4 is a version of the directivity pattern of FIG. 3B rotated clockwise by about 45 degrees, as shown in FIG. 3C.

When the contact arm 8c of the changeover switch 8 is contacted with the contact 8a, with the contact arms 12c and 14c of the changeover switches 12 and 14 contacting the contacts 12b and 14b, respectively, and with the contact arm 22c of the changeover switch 22 contacting the contact 22a, the combiner 18 is supplied with a phase-inverted version of the reception signal from the dipole antenna 2 and the reception signal from the dipole antenna 4, and a signal resulting from combining these two signals is developed at the output terminal of the combiner 18. The composite directivity pattern of the combined signals is a version of the composite directivity pattern shown in FIG. 3C, rotated clockwise by about 45 degrees, as shown in FIG. 3D.

By changing the positions of the contact arms 8c, 12c, 14c and 22c of the changeover switches 8, 12, 14 and 22, in a manner as described above, the direction or orientation of the composite directivity of the dipole antennas 2 and 4 can be changed. It should be noted that, by connecting level-adjusting means, e.g. a variable attenuator, to each of the input terminals of the combiner 18 in order to adjust the levels of the reception signals from the dipole antennas 2 and 4 applied to the combiner 18, a finer adjustment of the composite directivity pattern can be realized.

An output signal of the combiner 18 is applied to a high-pass filter (HPF) 26 having a cutoff frequency so determined as to pass therethrough the reception signals or UHF-band television signals from the dipole antennas 2 and 4.

The variable directivity antenna apparatus 1 described above includes also a VHF-band receiving antenna 28 for receiving VHF-band television broadcast signals, as shown in FIG. 4. A reception signal received at the receiving antenna 28 is applied to a band-pass filter (BPF) 30 having its cutoff frequency so determined as to pass VHF-band television broadcast signals therethrough.

An output signal of the high-pass filter 26 is coupled to a contact 32a of a changeover switch 32, and an output signal of the band-pass filter 30 is coupled to a contact 32b of the changeover switch 32. The changeover switch 32 also has a contact arm 32c, which is placed to contact either of the contacts 32a and 32b. With the contact arm 32c contacting the contact 32a, the output signal from the high-pass filter 26 (i.e. a UHF-band television broadcast signal) is developed at the contact arm 32c, while, with the contact arm 32c contacting the contact 32b, the output signal from the band-pass filter 30 (i.e. a VHF-band television broadcast signal) is developed at the contact arm 32c.

The contact arm 32c of the changeover switch 32 is connected to a contact arm 34c of a changeover switch 34, which also has contacts 34a and 34b. The contact arm 34c is brought into contact with either of the contacts 34a and 34b. The contact 34a of the changeover switch 34 is connected to an input of an amplifier 36, which has its output connected to a contact 38a of a changeover switch 38. The changeover switch 38 also has a contact 38b and a contact arm 38c. The contact 38b is connected to the contact 34b of the changeover switch 34. The contact arm 38c is brought into contact with either of the contacts 38a and 38b, and is connected to an output terminal 40.

Thus, by placing the contact arms 34c and 38c of the changeover switches 34 and 38 to contact the contacts 34a and 38a, respectively, the UHF-band television broadcast signal, which is the output of the high-pass filter 26, or the VHF-band television broadcast signal, which is the output of the band-pass filter 30, as selected by the changeover switch 32, is amplified in the amplifier 36, and the amplified signal is developed at the output terminal 40. On the other hand, by placing the contact arms 34c and 38c of the changeover switches 34 and 38 to contact the contacts 34b and 38b, respectively, the output of the high-pass filter 26 or the output of the band-pass filter 30, as selected by the changeover switch 32, is developed, as it is, at the output terminal 40, without being amplified.

The output terminal 40 is connected via a coaxial cable 42 to a control box 44, which, in turn, is connected to a television receiver 46, as shown in FIG. 5A. In this manner, the UHF-band television broadcast signal or the VHF-band television broadcast signal from the high-pass filter 26 or the band-pass filter 30, developed at the output terminal 40, is coupled to the television receiver 46.

Control means, e.g. a control unit 48 shown in FIG. 1, controls the switching operation of the changeover switches 8, 12, 14, 22, 32, 34 and 38, in accordance with a command externally applied thereto. The external command to be applied to the control unit 48 is generated in the control box 44 in response to operation of the television receiver 46, for example, and is applied to the output terminal 40 through the coaxial cable 42. The external command may be an ASK signal, for example. The ASK signal is applied to a detecting unit 50 through the output terminal 40, and is detected therein. The resulting detection signal is applied to control unit 48. In accordance with the command the ASK signal represents, the changeover switches 8, 12, 14, 22, 32, 34 and 38 are switching-controlled to orient the directivity in a desired one of the orientations shown in FIGS. 3A through 3D. Thus, the television receiver 46 can be operated to orient the directivity of the variable directivity antenna apparatus 1, in situ, to the direction from which a UHF-band television broadcast signal comes, in order to receive the UHF-band television broadcast signal well, and also to receive a VHF-band television broadcast signal well. Furthermore, if it is necessary to amplify the received VHF-band or UHF-band television broadcast signal in the amplifier 36, a command can be given in the form of the ASK signal to make the television signal amplified.

The operating power supply, e.g. a +12 V DC voltage, for operating the variable directivity antenna apparatus 1 can be provided by the television receiver 46, too, and is supplied to the output terminal 40 from the control box 44 through the coaxial cable 42. The power supply DC voltage is then applied through a reverse-current blocking diode 52 to a power supply unit 54, which powers the amplifiers 6, 26 and 36.

The dipole antennas 2 and 4 and the circuit, shown in FIG. 2, of the variable directivity antenna apparatus 1 are housed in a disc-shaped member 56 shown in FIG. 4. The VHF-band receiving antenna 28 and the output terminal 40 are mounted on a base 58, which also supports the disc-shaped member 56.

In order to vary the direction of the antenna directivity of the variable directivity antenna apparatus 1, it is necessary for the television receiver 46 and the control box 44 to be used together as shown in FIG. 5A. The television receiver 46 and the control box 44 are adapted to be used with the variable directivity antenna apparatus 1, and the control box 44 is arranged to provide the directivity varying ASK signal.

There is a possibility that the variable directivity antenna apparatus 1 need to be used with a common television receiver 60, which is not for exclusive use with the variable directivity antenna apparatus 1, as shown in FIG. 5B. In such case, the direction of the directivity of the variable directivity antenna apparatus 1 is not required to be varied. However, the variable directivity antenna apparatus 1 has to be supplied with operating power therefor. For that purpose, a power supply terminal 62 is formed on the base 58, as shown in FIG. 4, and a power supply adapter 64, which provides a +12 V DC voltage, is connected to the power supply terminal 62, as shown in FIG. 5B. The output terminal 40 is connected to the television receiver 60 via a coaxial cable 66.

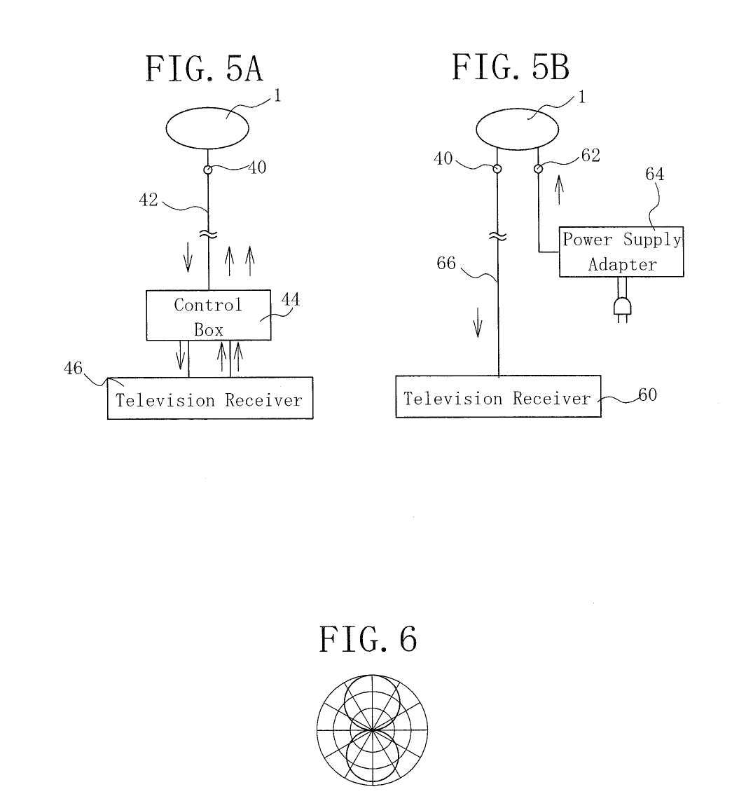

As shown in FIG. 2, the power supply terminal 62 is connected to the power supply unit 54 through a reverse-current blocking diode 68, so that the +12 V DC voltage developed at the power supply terminal 62 can be coupled to the power supply unit 54. A voltage detecting unit 70 detects whether or not the +12 V DC voltage is supplied to the power supply terminal 62. If the voltage detecting unit 70 detects the +12 V DC voltage, it notifies the detection to the control unit 48, and the control unit 48 changes the changeover switches 8, 12, 14, 22, 32, 34 and 38 from the state in which the switches 8, 12, 14, 22, 32, 34 and 38 are switching-controlled in accordance with the above-described ASK signal, to the state where the switches 8, 12, 14, 22, 32, 34 and 38 are switching-controlled to orient the directivity of the antenna apparatus 1 to a particular direction, e.g. the direction shown in FIG. 6, set through a separately provided switch 72 associated with the control unit 48 and also to cause the reception signal to be amplified, when required, in the amplifier 36. The direction set through the setting switch 72 may be changeable. It should be noted that, when no voltage is detected at the power supply terminal 62 by the voltage detecting unit 70, the control unit 48 provides the above-described control in accordance with the ASK signal. The setting switch 72 may be, for example, a sliding switch or a revolving switch, and may be disposed on the front surface of the base 58 or on the front part of the antenna, although not shown in FIG. 4.

Thus, the directivity antenna apparatus 1 with the above-described arrangement, when used with the television receiver 46 and the control box 44, can be operated as an antenna apparatus of which direction of directivity can be varied, or can be used as an antenna apparatus exhibiting the directivity pattern orientated in a particular desired direction when used with the common television receiver 60 and the power supply adapter 64. Thus, the variable directivity antenna apparatus 1 can exhibit wider utility.

In the above-described embodiment, the dipole antennas 2 and 4 exhibiting an 8-shaped directivity pattern are disposed to orthogonally cross each other, but the invention is not limited to such arrangement. For example, two directional antennas, e.g. Yagi antennas, may be used, instead, which are disposed to cross each other at right angles. In this case, however, a phase inverting circuit should be associated with each of the Yagi antennas, and the two Yagi antennas must be switching-controlled between a state where the reception signals from them are outputted without being phase-inverted and a state where the reception signals are phase-inverted before being outputted. The changeover switches 8, 12, 14, 22, 32, 34 and 38 may be mechanical changeover switches, or may be electronic changeover switches formed of semiconductor devices, e.g. PIN diodes. Instead of providing a control to make the directivity of the antenna apparatus 1 fixed upon detection of the coupling of the power supply adapter 64 to the power supply terminal 62, as in the above-described embodiment, a control signal to cause the directivity to be fixed may be provided to the control unit 48 through a manual operation of a switch, which may be disposed, for example, on the disc-shaped member 56 or the base 58 shown in FIG. 4. Also, instead of supplying a detection signal representing the detection of a voltage by the voltage detecting unit 70, a function to detect the connection of the power supply adapter 64 to the power supply terminal 62 may be provided to the system so that a detection signal representing such connection can be supplied to the control unit 48.

What is claimed is:

1. A variable directivity antenna apparatus having an output terminal at which a reception signal transmitted through a transmission line is developed as an output, said variable directivity antenna apparatus having the orientation of directivity thereof varied in response to a directivity control signal supplied to said output terminal through said transmission line;
wherein said variable directivity antenna apparatus further includes switching means for fixing the direction of directivity of said variable directivity antenna apparatus to a predetermined direction, when so operated.

2. The variable directivity antenna apparatus according to claim 1, wherein said variable directivity antenna apparatus is operated either from power supplied to said output terminal through said transmission line or from power supplied to a separately provided power supply terminal, said switching means being switched so as to fix the direction of directivity of said variable directivity antenna apparatus in response to supply of power to said separately provided power supply terminal.

3. The variable directivity antenna apparatus according to claim 1, wherein said variable directivity antenna apparatus comprises a plurality of antenna elements, and directivity varying means for electrically processing reception signals from said antenna elements to vary the direction of directivity of said variable directivity antenna apparatus; said switching means providing a directivity fixing control signal, when so operated; said directivity varying means processing said reception signals to vary the direction of directivity in response to said directivity control signal and processing said reception signals to fix the direction of directivity in response to said directivity fixing control signal.

4. The variable directivity antenna apparatus according to claim 2, wherein said variable directivity antenna apparatus comprises a plurality of antenna elements, and directivity varying means for electrically processing reception signals from said antenna elements to vary the direction of directivity of said variable directivity antenna apparatus; said switching means providing a directivity fixing control signal, when so operated; said directivity varying means processing said reception signals to vary the direction of directivity in response to said directivity control signal and processing said reception signals to fix the direction of directivity in response to said directivity fixing control signal.

5. The variable directivity antenna apparatus according to claim 2, further comprising amplifying means for amplifying said reception signals and providing the amplified reception signals to said output terminals, said amplifying means being operated when operating power for said variable directivity antenna apparatus is supplied to said output terminal or to said separately provided power supply terminal.

6. The variable directivity antenna apparatus according to claim 3, further comprising amplifying means for amplifying said reception signals and providing the amplified reception signals to said output terminals, said amplifying means being operated when operating power for said variable directivity antenna apparatus is supplied to said output terminal or to said separately provided power supply terminal.

7. The variable directivity antenna apparatus according to claim 4, further comprising amplifying means for amplifying said reception signals and providing the amplified reception signals to said output terminals, said amplifying means being operated when operating power for said variable directivity antenna apparatus is supplied to said output terminal or to said separately provided power supply terminal.
